(19) United States
(12) Patent Application Publication
(10) Pub. No.: US 2025/0348920 A1
(43) Pub. Date: Nov. 13, 2025

(54) CATEGORIZED FAVORITE FOOD SOCIAL NETWORK

(71) Applicant: Shawn Patterson, Naples, FL (US)

(72) Inventor: Shawn Patterson, Naples, FL (US)

(21) Appl. No.: 18/616,138

(22) Filed: Mar. 25, 2024

Related U.S. Application Data
(60) Provisional application No. 63/454,635, filed on Mar. 25, 2023.
(60) Provisional application No. 63/461,080, filed on Apr. 21, 2023.

(51) Int. Cl. G06Q 30/0601; G06Q 50/12

(52) U.S. Cl. CPC G06Q 30/06312; G06Q 30/0639

(57) ABSTRACT

Computer-implemented methods, systems, and computer-readable media for a categorized favorite food user generated content/social network are described.

### FIELD

Some implementations are generally related to social networks and customer review systems, and, more particularly to categorized favorite food social network systems and methods.

### BRIEF DESCRIPTION OF THE DRAWINGS

FIG. 1 is a block diagram of an example system and a network environment which may be used for one or more implementations described herein.

FIG. 2 is a diagram showing components of a categorized favorite food social network in accordance with some implementations.

FIG. 3 is a diagram of an example CMS module in accordance with some implementations.

FIG. 4 is a diagram of an example user module in accordance with some implementations.

FIG. 5 is a diagram of an example venue module in accordance with some implementations.

FIG. 6 is a block diagram of an example computing device which may be used for one or more implementations described herein.

### DETAILED DESCRIPTION

Some implementations include categorized favorite food social network methods and systems. Further, some implementations can include BOAT Brews (e.g., a beer review/favorite and finding app) and GOAT Glass (e.g., a wine review/favorite and finding app). In general, the methods and systems described herein can be applied to any food or beverage type, category, region, etc.

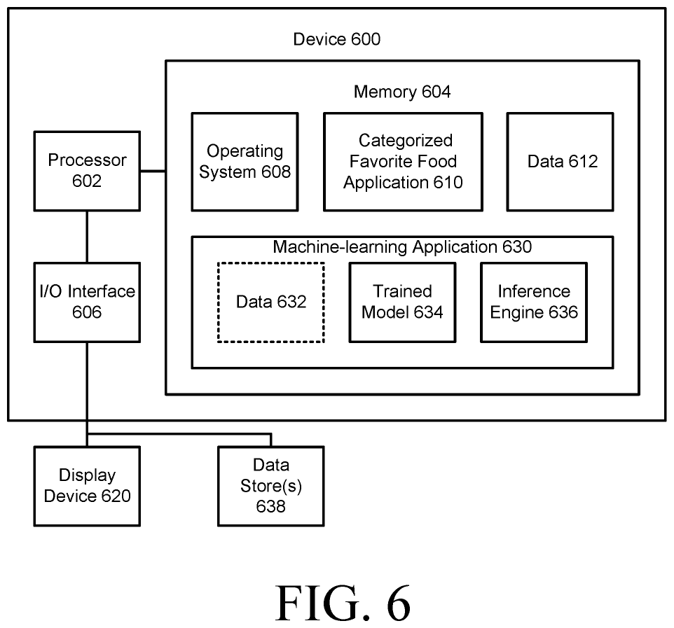

When performing categorized favorite food social network functions, it may be helpful for a system to suggest foods or venues to a user and/or to make predictions about foods or venues a user may like. To make predictions or suggestions, a probabilistic model (or other model as described below in conjunction with FIG. 6) can be used to make an inference (or prediction) about aspects of food or venues such as recommend a food or venue. Accordingly, it may be helpful to make an inference regarding a probability that a user will like a given food or venue. Other aspects can be predicted or suggested as described below.

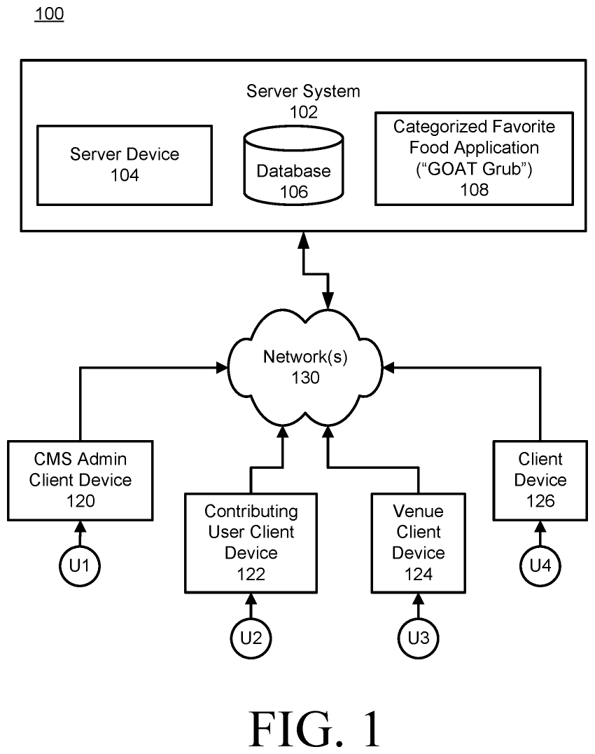

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and a categorized favorite food social network application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide categorized favorite food social network functions.

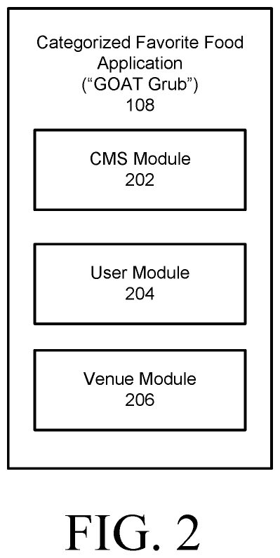

FIG. 2 is a diagram showing components of a categorized favorite food social network in accordance with some implementations. For example, FIG. 2 shows a content management system (CMS) module 202, which can include a web-based platform. In some implementations, the Content Management System module 202 can be the controlling platform of the categorized favorite food social network.

The categorized favorite food social network application 108 also includes a user module 204, which can include a mobile application platform. The categorized favorite food social network creates a fun and visually appealing space for users to list/share their GOAT (or favorite) foods, while discovering new cuisines to explore locally or in travel. As used herein, the term GOAT refers to Greatest of All Time.

The categorized favorite food social network application 108 also includes a venue portal module 206, which can include a web platform. In some implementations, a web portal for venues that is free and gives venues access to analytics of how their restaurant is performing on the app. The venue portal can also provide access to advertising opportunities within the app for venues.

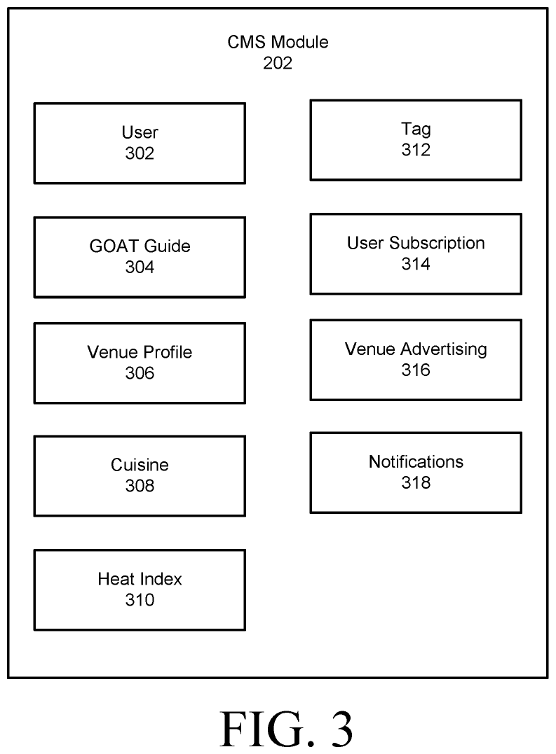

FIG. 3 is a diagram of an example CMS module in accordance with some implementations. The CMS module 202 can include user management functions 302. The user management functions 302 can include sections for analytics, user account information 302, GOAT Guide management 304, venue profile management 306, cuisine

In some implementations, the analytics can include one or more of: Total Active Users, Total All-time Users, Users by Location, Type of Cuisine, and Cuisine/Restaurants preferred by location. The CMS can also include the ability to view all user accounts.

In some implementations, User Account Information can include one or more of: First Name, Last Name, Current City & State, Email, OTP (one-time password), Phone Number, Profile Image, Password, Password Confirmation, and Subscription information (e.g., Payment Information, Link to Stripe subscription, Ability to cancel if possible from the CMS, Payment History).

The CMS system can also include functions to view, edit, and delete user GOATs. A user's GOATs can include local and global GOATs categorized based on one or more of Food Type, Cuisine Type, Meal Type, and Restaurant Name.

The CMS system also includes GOAT guide management functions, which can include analytics (e.g., Total Active Users, Total All-time Users, Users by Location, Type of Cuisine, and Cuisine/Restaurants preferred by location). In some implementations, the CMS can provide an ability to view, invite and manage GOAT Guide accounts.

GOAT Guide Account Information can include one or more of First Name, Last Name, Current City & State, Email, OTP, Phone Number, Profile Image, Password, Password Confirmation, Link to GOAT Guides Blog (Will appear on GOAT app), and Subscription

The GOAT Guide Management functions include functions to: view, edit, or delete GOAT Guide GOATs (locally and globally) for Food Type, Cuisine Type, Meal Type, Restaurant Name, GOAT Guide metropolitan location, and number of GOATs given.

The CMS module 202 includes a venue profile management 306 that provides analytics including:

Number of GOATs given (e.g., GOATs given by day, GOATs given by week, GOATs given by month, and GOATs given by year)

Number of GOATs lost (e.g., GOATs lost by day, GOATs lost by week, GOATs lost by month, GOATs lost by year)

Number of profile clicks/views by users (e.g., User views by day, User views by week, User views by month, User views by year)

Types of cuisine/food items searched (e.g., Most searched menu items and Least searched menu items)

Each venue in the system can include a profile that includes one or more of: Venue Name, Venue Location, Venue Phone Number, Venue Email Address, Venue Website Hyperlink (if available), Venue Heat Index, Number of GOATs given, Venue Deals/Coupons, RSVP (e.g., OpenTable Integration). Users can view, edit, and delete venue profile information. Users can create a new venue, which can include one or more of Venue Name, Venue Location, Venue Phone Number, Venue Email Address, Venue Website Hyperlink (if available).

The CMS module includes a cuisine category management section 308 that permits users to view cuisine categories, view meal categories, and moderate content. Cuisine categories can include African, American, Asian, European, Indian, Italian, Middle Eastern, Spanish, etc. A Category Venues section permits users to view all venues organized in a category and add venues to multiple categories.

Users can also view Meal Categories including Breakfast, Brunch, Lunch, Dinner, Dessert, Snack, and Late Night Eats. A Categories Venue section permits users to view, add, edit meal categories, and to view all venues organized in a category and add venues to multiple categories.

In some implementations, the CMS module 202 can provide an ability to associate food types with specific meal categories For example, pizza can be associated with Brunch, Lunch Dinner and Late Night Eats

The CMS can permit a user to associate food types with specific Cuisine and Meal Type categories. Further, the CMS can have the ability to select food types that appear on the search term autocomplete functionality for Cuisine and Meal Type searches.

The CMS can provide users with an ability to view and moderate all venue and user content. The CMS will have the ability to view all user GOAT submissions marked as Shenanigans and manage them as necessary

The CMS module 202 also includes a heat index management section 310.

The CMS will have the ability to manage the heat index that can be added to venues. An example heat index represents a level of GOATs that a venue has achieved:
Green (10 or less GOATs given)
Yellow (10-500 GOATs given)
Orange (750-999 GOATs given)
Red (1000+ GOATs given)
Blue (“Promoted” Index Level/Pay to Play)

The system statistics can also include a number of venues with any given/earned heat index, and a list of venues with any given/earned heat index. The heat index section 310 can be configured to permit a user to View, Edit, and Delete heat indexes. Also, the system can permit a user to add a new heat index level.

In some implementations, the heat index feature can be part of a “Find Food” search function and/or results of a Find Food search. The palate profile (described below) can be based on a “Food Found” function.

The CMS module 202 can include a tag management section 312. The tag management section permits a user to manage tags that can be added to venues.

Users can View, edit, add, or delete tags. Tag information can include one or more of: tag name, number of venues using the tag, and list of venues using the tag.

The user subscription management section 314 includes information about user subscriptions such as Analytics (e.g., Total Subscriber Revenue, Total Active Subscribers, and Total All Time Subscribers). The user subscription management section 314 also permits a user to view a list of all active subscribers. Subscriber information can include one or more of the following: Name, Subscribed Since, Membership Level (Free/Premium), Payment Method, and Link to Stripe subscription.

The user subscription section 314 also provides ability for a user to cancel subscription from CMS if possible and View list of all Past Subscribers (e.g., Name, Subscribed From—To, Membership Level (Free/Premium), and Link to Stripe in-active subscription).

The CMS module also includes a venue advertising management section 316 that includes Analytics (e.g., Total Venue Advertising Revenue, Total Active Venue Advertisements, and Total All Time Venue Advertisements). A View list of all Advertising Venues function lists advertising venue information including Name, Advertising Since, Payment Method, and Link to Stripe subscription (with Ability to cancel advertising from CMS if possible). A function to View list of all Past Advertising Venues (e.g., showing Name, Advertised From—To, Link to Stripe in-active subscription).

Venues would need to pass a certain GOAT level before they are able to advertise on the platform. The Admin will be able to control this functionality from the CMS and adjust as needed on a universal and per venue basis.

The notifications section 318 provides Analytics (e.g., Total Notifications Sent and Total Notification Opens). The CMS will have the ability to create, manage and edit Notifications sent out to users. Notifications can be One-Time or Scheduled.

The functions include viewing sent and scheduled notifications.

Sent notification information can include one or more of: Notification Information, Title, Message, Image, Sent Date/Time, Recurring (e.g., Never, Daily, Weekly, Bi-weekly, or Monthly), and Notification Analytics (e.g., Notification Opens).

Scheduled notification information can include one or more of: Title, Message, Image, Scheduled (Date/Time), Recurring (e.g., Never, Daily, Weekly, Bi-weekly, Monthly). Users can view, edit, or delete a scheduled notification.

The process of scheduling a new notification can include:
Selecting a User Type;
Selecting Link Tab (Optional);
Selecting Linked Resource (Optional);
Entering a Time (e.g., Now or Scheduled and Date Time);
Selecting a Repeat Option (e.g., Never, Daily, Weekly, Bi-weekly, Monthly);
Entering Title;
Entering Message; and
Selecting an Image (Optional).

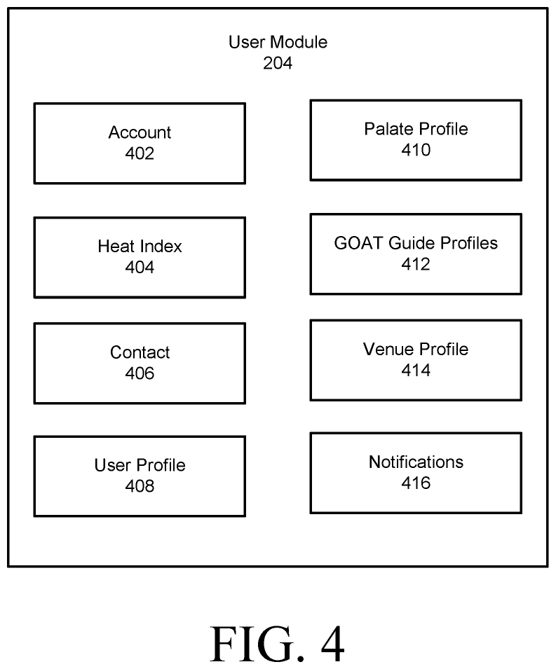

FIG. 4 is a diagram of an example user module 204 in accordance with some implementations. The user module 204 includes an account section 402. The account section 402 includes a user onboarding function that permits new users to create their accounts.

During the onboarding process, users will have the ability to create their account using one or more of: First Name, Last Name, Current City & State, Email, Phone Number, OTP, Profile Image, Password, and Password Confirmation.

Users will have the ability to reset their password by submitting their email address and receiving a reset link.

The account section 402 also includes a management function. Users will have access to all of their information shared in the application. Users will have the ability to delete their account.

The account section 402 also includes subscription functionality in which users will have the ability to subscribe to different levels of membership: Free (provides access to the application and the free application features), Premium (Provides access to premium application features including more defined venue/food searches). All levels of membership will include application access. Subscriptions canceled will run through completion of the paid-for-term, after which it will not recur and cancel.

The user module 204 includes a heat index section that permits a user to perform a cuisine search. For example, users will have the ability to search for specific cuisine, meal types or item types. Users will have the ability to search for multiple food items at the same time. For example, if users are ambivalent about French toast vs waffles, they can include both in their search query. Users will have the ability to toggle between a map and list view of the venue options in the area they are searching for.

Users will have the ability to refine their search by the following: Cuisine Type (e.g., African, American, Asian, European, Indian, Italian, Middle Eastern, Spanish, and Other Cuisine Types (CMS Generated); or Meal Type (e.g., Breakfast, Brunch, Lunch, Dinner, Dessert, Snack, Late Night Eats, and Other Meal Types (CMS Generated).

Some implementations can include Search Term Autocomplete in which Users will have the ability to select from search term autocomplete food types. Further, users will have the ability to refine their food search using filters. For example, if a user searches for Breakfast and a list of Breakfast places populates, the user will have the ability to refine the search based on Breakfast foods. Pancakes, eggs, waffles, etc.

Users can also search by Item Type. Users will have the ability to search by specific menu items, for example, French Toast, Palak Paneer, Thin Crust Pizza, Tempura Shrimp, Other Item Types.

Users will have the ability to refine their food search using filters, for example, if a user searches for pizza and a list of pizza places populates, the user will have the ability to refine the search based on Pizza styles. Deep dish, thin crust, etc.

Some implementations can include a Franchise Filter (Toggle On/Off) that provides users with an ability to use a toggle to filter out franchises in the area. This ability allows users to view franchises if they are looking for one specifically but also allow users to only view local small businesses in their area.

For example, if a user is looking for a Culver's, the user will keep the franchise toggle on.

For example, is a user is looking for a local burger join, they will turn the franchise toggle off.

Users can also search by location locally or nationally, for example a user is planning a trip to Austin, TX and would like to find the GOAT Korean restaurant in the area.

Geolocation will present restaurants based on the user's current location.

GOAT's Given

Users will have the ability to sort food search by the GOAT Heat Index. The GOAT filters are as followed:
Green (10 or less GOATs given)
Yellow (10-500 GOATs given)
Orange (750-999 GOATs given)
Red (1000+ GOATs given)

Exception: Blue (Potential “Promoted” Index Level/Pay to Play)—This GOAT Heat Index will not be available for users to filter out.

The contact us section 406 provides users with an ability to submit recommendations to the GOAT Grub team via a submission page. This submission page can have a dropdown menu with CMS managed topic filters:
New Cuisine Suggestion
New Food Item Suggestion
New Restaurant Suggestion
Other Suggestion

After selecting from the dropdown menu, the user will have the ability to submit a note to the admin team with their suggestions.

The user profile section 408 includes:
GOATS—Users will have the ability to view all of their GOAT venues in their profile. Users will have the ability to add GOATs to their profile based on the following parameters: GOAT Food Type (Locally, Globally), GOAT Cuisine Type (Locally, Globally), GOAT Meal Type (Locally, Globally), and/or GOAT Restaurant Name (Locally, Globally). A user has the ability to view, edit, or delete GOATs.

Users will have the ability to update their GOAT for any cuisine, dish, and meal type at any time. For example, a user has Joey D's as their “GOAT-Pizza” but then the user tries The Crust. At this point, the user comes to their senses and rightfully updates their GOAT-Pizza to be The Crust.

Users will have the ability to delete their GOAT for any cuisine, dish, and meal type at any time. For example, a user has found that the quality of their GOAT has diminished over time and they no longer view them as a GOAT. The user has not necessarily found a new GOAT yet, but they no longer view their current GOAT as such. When a user updates their GOAT, it will adjust the GOAT rankings of the appropriate venues and update the Heat Index, when applicable.

The user module 204 includes a palate profile section 410 where users will be encouraged to add their GOAT venues for different cuisines and meals through the use of a progress tracker or a Food Found function. As a user assigns GOATS for different food categories, their progress tracker will continue to fill until their palate profile is complete. For example, a user may be at 95% completion on their palate profile because they have not assigned a GOAT for Breakfast and a GOAT for American cuisine.

In some implementations, an ‘N/A’ option is provided in lieu of a GOAT venue for any of the Cuisine and Meal categories. This could be beneficial if users have an aversion to specific foods or have dietary restrictions that prevent them from exploring specific cuisines. This condition would also allow them to complete their palate profile without discrimination of food aversions.

### User Incentivization

Users who complete over a certain number of GOATs will be able to receive special discounts. For example: once a user completes their palate profile, they will receive a one-month free trial of GOAT Grub premium by using the promo code GOATGLOAT2022

The goat guides user profile section 412 to provide functions for GOAT guides similar to those for regular users. In some implementations, GOAT Guides will have the same or similar functionalities outlined for users. GOAT Guides will be listed under a GOAT Guides Tab within the application for users to easily access. The GOAT Guides Tab will highlight GOAT Guides local to the area that the user is searching in.

For example, a user is planning a trip to Austin, TX and searching for local restaurants in the area. The GOAT Guides Tab will show GOAT Guides who have given GOATs in the local area.

GOAT Guides will have the ability to add a hyperlink (for their Blog) to their profile.

This hyperlink will become active after 10 successful GOAT reviews.

GOAT Guides will have a Certified GOAT Guide emblem on their user profile.

The user module 204 includes a venue profile section 414.

Users will have access to the following Venue Profile information:
Venue Name
Venue Location
Venue Phone Number
Venue Email Address
Venue Website Hyperlink (if available)
Venue Heat Index
Number of GOATs given
Venue Deals/Coupons
RSVP (If available, OpenTable Integration or the like)
Users will have the ability to flag a venue for admin review

The term “Shenanigans” can be utilized within the application and CMS platform in lieu of the term “Flag” or “Flag an Item.” For example, a venue has recently closed permanently but is still shown as open in the GOAT Grub application.

The user module 204 includes a NOTIFICATIONS section 416. Users will have the ability to receive a variety of push & email notifications. Users will have the ability to customize their preferred notifications as well as the delivery method.

### Notification Type

CMS Generated

Palate Profile

Completion Reminders

New Venues

Venues recently added to the GOAT Grub App

Venues “Heating Up”

Venues rising in the GOAT Grub Heat Index

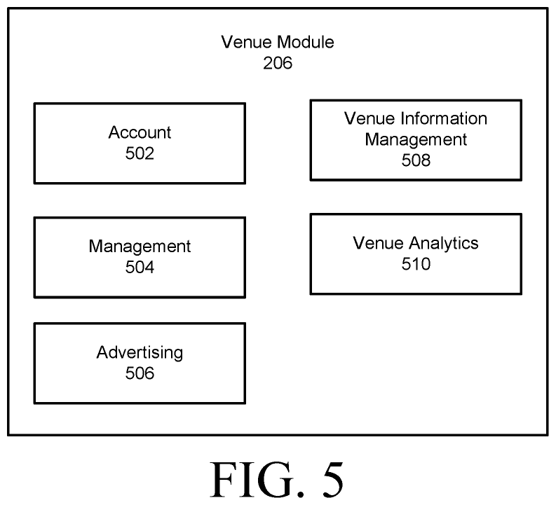

For example, a venue recently went from an Orange in the heat index to a Red FIG. 5 is a diagram of an example venue module in accordance with some implementations. An account section 502 includes an onboarding process. For example, venue owners will have the ability to click a hyperlink within their page that says something like “Is this your business? Claim it here!”, which will lead to a Contact Form. Venue owners will be asked to fill out a contact form to receive additional information about the advertisement opportunities through GOAT Grub. The contact form fields can include one or more of the following: First Name, Last Name, Phone Number, Email Address, Best Time to Reach Them. Venue owners will have the ability to create their account using their: First Name, Last Name, Current City & State, Email, OTP, Phone Number, Profile Image, Password, and Password Confirmation. A Claiming Additional Venues feature permits venue owners to select other restaurants they also own and have all restaurants be submitted for approval at the same time. Venue owners will have the ability to reset their password by submitting their email address and receiving a reset link.

The management section 504 provides venue owners with access to all of their information shared in the application.

The venue module 206 also includes an advertising section 506. Within the advertising section 506, venue owners will have the ability to pay for advertising opportunities within the application:

In some implementations, advertising can include a HEAT Index: ‘Pay to Play’ Blue Heat, which permits restaurants to remain on the HEAT Index map and list as long as the venue mentions the keywords that the user is searching for. The advertising venues would show regardless of GOAT's received, as long as they align with the users' keyword search. This would allow advertisers to populate at the top of the list in a more prominent row. Venues would have the ability to upload a venue photo which would show up on their list view.

The venue could advertise that they offer coupons/discounts and the venue line item could say “coupons” to draw the eye and attention of the user. Advertisements canceled will run through completion of the paid-for-term, after which it will not recur and cancel.

The venue module 206 also includes a venue information management section 508 that provides venue users with an ability to update/edit their venue information, which can include one or more of:
Venue Name
Venue Address
Venue Website Hyperlink
Venue Phone Number
Venue Menu Items
Venue Profile Image (Pay to Play venues only)
Venue Coupons/Special Offers (Pay to Play venues only)

Advertising Venues will have access to an additional section that will allow them to add venue coupons/special offers. Advertising Venues will be able to add coupons/special offers by submitting:
Promo Title
Promo Text Descriptions
Expiration Date
Images (Optional)
Hyperlinks (Optional)

### Example

Title: 30% OFF THURSDAYS!!

Description: Bring this coupon to any participating Pincher's and receive 30% off your meal on Thursdays. Restrictions Apply. Limit of 1 redemption per household. Promo value valid with purchases up to $100. Discount valid Dec. 1, 2022-Dec. 31, 2022.

Images: Coupon Image

Hyperlink: Redirection to the coupon page in the venue website

Venue users can also access Advertising Opportunities. Venues will have the ability to click a hyperlink within their page (e.g., “Interested in Advertising Opportunities? Click Here!”), which will take the venue user to a contact form. Venue users will be asked to fill out a contact form to receive additional information about the advertisement opportunities through GOAT Grub. The contact form can include one or more of:
First Name
Last Name
Phone Number
Email Address
Best Time to Reach Them

In some implementations, advertisements canceled will run through completion of the paid-for-term, after which it will not recur and cancel.

The venue analytics section 510 provides venue users with the ability to view their venue performance analytics.

Venue Analytics can include one or more of:
Number of GOATs given (e.g., GOATs given by day, GOATs given by week, GOATs given by month, and GOATs given by year)
Number of GOATs lost (e.g., GOATs lost by day, GOATs lost by week, GOATs lost by month, and GOATs lost by year)
Number of profile clicks/views by users (e.g., User views by day, User views by week, User views by month, and User views by year).

Types of cuisine/food items searched (e.g., most searched menu items or least searched menu items).

Various implementations of features described herein can use any type of system and/or service. Any type of electronic device can make use of features described herein. Some implementations can provide one or more features described herein on client or server devices disconnected from or intermittently connected to computer networks.

FIG. 6 is a block diagram of an example device 600 which may be used to implement one or more features described herein. In one example, device 600 may be used to implement a client device, e.g., any of client devices 120-126 shown in FIG. 1. Alternatively, device 600 can implement a server device, e.g., server device 104, etc. In some implementations, device 600 may be used to implement a client device, a server device, or a combination of the above. Device 600 can be any suitable computer system, server, or other electronic or hardware device as described above.

One or more methods described herein can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 600 includes a processor 602, a memory 604, and I/O interface 606. Processor 602 can be one or more processors and/or processing circuits to execute program code and control basic operations of the device 600. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 602 may include one or more co-processors that implement neural-network processing. In some implementations, processor 602 may be a processor that processes data to produce probabilistic output, e.g., the output produced by processor 602 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602 and may be any suitable processor-readable storage medium, such as random access memory (RAM), read-only memory (ROM), Electrically Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 608, machine-learning application 630, categorized favorite food social network application 610, and application data 612. Other applications may include applications such as a data display engine, web hosting engine, image display engine, notification engine, social networking engine, etc. In some implementations, the machine-learning application 630 and categorized favorite food social network 610 can each include instructions that enable processor 602 to perform functions described herein.

The machine-learning application 630 can include one or more NER implementations for which supervised and/or unsupervised learning can be used. The machine learning models can include multi-task learning based models, residual task bidirectional LSTM (long short-term memory) with conditional random fields, statistical NER, etc. The device can also include a categorized favorite food social network 610 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 630 may utilize Bayesian classifiers, support vector machines, neural networks, or other learning techniques. In some implementations, machine-learning application 630 may include a trained model 634, an inference engine 636, and data 632. In some implementations, data 432 may include training data, e.g., data used to generate trained model 634. For example, training data may include any type of data suitable for training a model for categorized favorite food social network tasks, such as images, labels, thresholds, etc. associated with foods or venues as described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 634, training data may include such user data. In implementations where users permit use of their respective user data, data 632 may include permitted data.

In some implementations, data 632 may include collected data such as user profile information and content relating to favorite foods and/or venues. In some implementations, training data may include synthetic data generated for the purpose of training, such as data that is not based on user input or activity in the context that is being trained, e.g., data generated from simulated conversations, computer-generated images, etc. In some implementations, machine-learning application 630 excludes data 632. For example, in these implementations, the trained model 634 may be generated, e.g., on a different device, and be provided as part of machine-learning application 630. In various implementations, the trained model 634 may be provided as a data file that includes a model structure or form, and associated weights. Inference engine 636 may read the data file for trained model 634 and implement a neural network with node connectivity, layers, and weights based on the model structure or form specified in trained model 634.

Machine-learning application 630 also includes a trained model 634. In some implementations, the trained model 634 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 632 or application data 612. Such data can include, for example, images, e.g., when the trained model is used for categorized favorite food social network functions. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In different implementations, the trained model 634 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 634 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 632, to produce a result.

For example, training may include applying supervised learning techniques. In supervised learning, the training data can include a plurality of inputs (e.g., a set of images) and a corresponding expected output for each input. Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner.

In another example, a model trained using unsupervised learning may cluster words based on the use of the words in data sources. In some implementations, unsupervised learning may be used to produce knowledge representations, e.g., that may be used by machine-learning application 630. In various implementations, a trained model includes a set of weights, or embeddings, corresponding to the model structure. In implementations where data 632 is omitted, machine-learning application 630 may include trained model 634 that is based on prior training, e.g., by a developer of the machine-learning application 630, by a third-party, etc. In some implementations, trained model 634 may include a set of weights that are fixed, e.g., downloaded from a server that provides the weights.

Machine-learning application 630 also includes an inference engine 636. Inference engine 636 is configured to apply the trained model 634 to data, such as application data 612, to provide an inference. In some implementations, inference engine 636 may include software code to be executed by processor 602. In some implementations, inference engine 636 may specify circuit configuration (e.g., for a programmable processor, for a field programmable gate array (FPGA), etc.) enabling processor 602 to apply the trained model. In some implementations, inference engine 636 may include software instructions, hardware instructions, or a combination. In some implementations, inference engine 636 may offer an application programming interface (API) that can be used by operating system 608 and/or categorized favorite food social network 610 to invoke inference engine 636, e.g., to apply trained model 634 to application data 612 to generate an inference.

Machine-learning application 630 may provide several technical advantages. For example, when trained model 634 is generated based on unsupervised learning, trained model 634 can be applied by inference engine 636 to produce knowledge representations (e.g., numeric representations) from input data, e.g., application data 612. For example, a model trained for categorized favorite food user generated content/social network tasks may produce predictions and confidences for given input information about food or venue. A model trained for suggesting foods or venues may produce a suggestion for one or more foods or venues based on input GOATs or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 636.

In some implementations, knowledge representations generated by machine-learning application 630 may be provided to a different device that conducts further processing, e.g., over a network. In such implementations, providing the knowledge representations rather than the images may provide a technical benefit, e.g., enable faster data transmission with reduced cost.

In some implementations, machine-learning application 630 may be implemented in an offline manner. In these implementations, trained model 634 may be generated in a first stage and provided as part of machine-learning application 630. In some implementations, machine-learning application 630 may be implemented in an online manner. For example, in such implementations, an application that invokes machine-learning application 630 (e.g., operating system 608, one or more of categorized favorite food social network 610 or other applications) may utilize an inference produced by machine-learning application 630, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 634, e.g., to update embeddings for trained model 634.

In some implementations, machine-learning application 630 may be implemented in a manner that can adapt to particular configuration of device 600 on which the machine-learning application 630 is executed. For example, machine-learning application 430 may determine a computational graph that utilizes available computational resources, e.g., processor 602. For example, if machine-learning application 630 is implemented as a distributed application on multiple devices, machine-learning application 630 may determine computations to be carried out on individual devices in a manner that optimizes computation. In another example, machine-learning application 630 may determine that processor 602 includes a GPU with a particular number of GPU cores (e.g., 1000) and implement the inference engine accordingly (e.g., as 1000 individual processes or threads).

In some implementations, machine-learning application 630 may implement an ensemble of trained models. For example, trained model 634 may include a plurality of trained models that are each applicable to same input data. In these implementations, machine-learning application 630 may choose a particular trained model, e.g., based on available computational resources, success rate with prior inferences, etc. In some implementations, machine-learning application 630 may execute inference engine 636 such that a plurality of trained models is applied. In these implementations, machine-learning application 630 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 608 or one or more other applications, e.g., categorized favorite food social network 610.

In different implementations, machine-learning application 630 can produce different types of outputs. For example, machine-learning application 630 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 630 may produce an output video with a particular effect applied, e.g., rendered in a comic-book or particular artist's style, when trained model 634 is trained using training data from the comic book or particular artist, etc. In some implementations, machine-learning application 630 may produce an output based on a format specified by an invoking application, e.g., operating system 608 or one or more applications, e.g., categorized favorite food social network 610. In some implementations, an invoking application may be another machine-learning application. For example, such configurations may be used in generative adversarial networks, where an invoking machine-learning application is trained using output from machine-learning application 630 and vice-versa.

Any of software in memory 604 can alternatively be stored on any other suitable storage location or computer-readable medium. In addition, memory 604 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. Interfaced devices can be included as part of the device 600 or can be separate and communicate with the device 600. For example, network communication devices, storage devices (e.g., memory and/or database 106), and input/output devices can communicate via I/O interface 606. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 606 can include one or more display devices 620 and one or more data stores 638 (as discussed above). The display devices 620 that can be used to display content, e.g., a user interface of an output application as described herein. Display device 620 can be connected to device 400 via local connections (e.g., display bus) and/or via networked connections and can be any suitable display device. Display device 620 can include any suitable display device such as an LCD, LED, or plasma display screen, CRT, television, monitor, touchscreen, 3-D display screen, or other visual display device. For example, display device 620 can be a flat display screen provided on a mobile device, multiple display screens provided in a goggles or headset device, or a monitor screen for a computer device.

The I/O interface 606 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 6 shows one block for each of processor 602, memory 604, I/O interface 606, and software blocks 608, 610, and 630. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While some components are described as performing blocks and operations as described in some implementations herein, any suitable component or combination of components of environment 100, device 600, similar systems, or any suitable processor or processors associated with such a system, may perform the blocks and operations described.

In some implementations, the categorized favorite food social network system could include a machine-learning model (as described herein) for tuning the system to potentially provide improved accuracy. Inputs to the machine learning model can include ICA labels, an image descriptor vector that describes appearance and includes semantic information about a categorized favorite food social network. Example machine-learning model input can include labels for a simple implementation and can be augmented with descriptor vector features for a more advanced implementation. Output of the machine-learning module can include a prediction of a food and/or venue.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A method comprising:
receiving a selection of a food type;
receiving a selection of a restaurant, where the restaurant has an associated geographic location;
generating a favorite food record including the food type and the selected restaurant;
updating a count of the food type associated with the selected restaurant;
receiving a search query including a search food type and a search geographic location; and
providing search results including a list of one or more restaurants within a given distance of the search geographic area having the search food type and a positive count of favorite food records associated with the search food type.
